(19) United States
(12) Patent Application Publication
(10) Pub. No.: US 2022/0366187 A1
(43) Pub. Date: Nov. 17, 2022

(54) SYSTEMS AND METHODS FOR GENERATING AN INTERPRETIVE BEHAVIORAL MODEL

(71) Applicant: Toyota Research Institute, Inc., Los Altos, CA (US)

(72) Inventors: Totte Harinen, San Francisco, CA (US); Alexandre L.S. Filipowicz, Mountain View, CA (US); Rumen Iliev, Millbrae, CA (US); Yanxia Zhang, Foster City, CA (US); Kent Lyons, Los Altos, CA (US); Charlene C. Wu, San Francisco, CA (US); Yin-Ying Chen, San Jose, CA (US); Yue Weng, San Mateo, CA (US); Abishek Komma, Mt. View, CA (US)

(73) Assignees: Toyota Research Institute, Inc., Los Altos, CA (US); Toyota Jidosha Kabushiki Kaisha, Aichi-Ken (JP)

(21) Appl. No.: 17/740,745

(22) Filed: May 10, 2022

Related U.S. Application Data
(60) Provisional application No. 63/187,134, filed on May 11, 2021.

(51) Int. Cl. G06K 9/62

(52) U.S. Cl. CPC G06K 9/6256; G06K 9/6234

(57) ABSTRACT

A method includes fitting a ML trained model to data features, the fitting generates complete data feature-set outputs that are associated with a first set of accuracy values, iteratively fitting, after an iterative removal of each data feature from the data feature-set, the ML trained model to subsets of the plurality of data features to determine respective reduced feature-set outputs, each subset lacks a different data feature of the plurality of data features, determining one or more of the reduced feature-set outputs as corresponding to a second set of accuracy values, designating the iteratively removed data features as accuracy-modifying data features, generating a first linear model, generating a second linear model based on one of the accuracy-modifying data features having a weight that is highest relative to respective different weights of the remaining ones of the accuracy-modifying data features, and identifying the second linear model as a generative model.

This application claims the benefit of U.S. Provisional Application Ser. No. 63/187,134, filed on May 11, 2021, the contents of which are incorporated by reference herein in their entirety.

### TECHNICAL FIELD

The embodiments described herein generally relate to generating an interpretive behavioral model, and more particularly, to generating an interpretive behavioral model that may be utilized to determine an extent to which an input within a dataset influences or causes an output.

### BACKGROUND

Various machine learning models may be fitted to a dataset in order to generate outputs. These machine learning models, when fitted to a robust and comprehensive input dataset, may generate highly accurate outputs. While accurate, these outputs may not be interpretable or provide information regarding one or more factors or characteristics present in the input dataset that resulted in the generated outputs. As such, while the outputs may be accurate and likely remain accurate across a large and varied dataset, the reasons for the generation of the output may remain unclear, rendering the machine learning models opaque and uninterpretable. While multiple behavioral models may better facilitate interpretation of input datasets and identification of one or more characteristics that influence an extent to which certain outputs may result from certain inputs, these behavioral models are tested within and accurate only within limited environments. With an increase in the robustness and diversity of the dataset, the efficacy of these behavioral models is reduced.

Accordingly, a need exists for alternative methods of generating an interpretive behavioral model that enables the interpretation of an extent to which one or more characteristics of data within an input dataset influences or causes the generation of one or more outputs.

### SUMMARY

In one embodiment, a method for generating an interpretive behavioral model is provided. The method is implemented by a computing device and includes fitting a machine learning trained model to a plurality of data features included as part of a data feature-set for identifying a generative model, the fitting generates complete data feature-set outputs that are associated with a first set of accuracy values, iteratively fitting, after an iterative removal of each data feature from the data feature-set, the machine learning trained model to subsets of the plurality of data features to determine respective reduced feature-set outputs, each subset lacks a different data feature of the plurality of data features, determining one or more of the reduced feature-set outputs as corresponding to a second set of accuracy values that are lower than the first set of accuracy values, designating the iteratively removed data features that are associated with the one or more of the reduced feature-set outputs corresponding to the second set of accuracy values that are lower than the first set of accuracy values as accuracy-modifying data features included as part of an accuracy-modifying data feature-set, generating a first linear model based on the accuracy-modifying data features, generating a second linear model that is based on one of the accuracy-modifying data features having a weight that is highest relative to a remaining ones of the accuracy-modifying data features, and identifying the second linear model as the generative model responsive to determining that the linear model accuracy value of the second linear model exceeds each of the first set of accuracy values.

In another embodiment, a system for generating an interpretive behavioral model is provided. The system includes one or more processors included as part of a computing device, and non-transitory computer readable medium storing instructions that, when executed by the one or more processors, cause the computing device to fit a machine learning trained model to a plurality of data features included as part of a data feature-set for identifying a generative model, the fitting generates complete data feature-set outputs that are associated with a first set of accuracy values, iteratively fit, after an iterative removal of each data feature from the data feature-set, the machine learning trained model to subsets of the plurality of data features to determine respective reduced feature-set outputs, each subset lacks a different data feature of the plurality of data features, determine one or more of the reduced feature-set outputs as corresponding to a second set of accuracy values that are lower than the first set of accuracy values, designate the iteratively removed data features that are associated with the one or more of the reduced feature-set outputs corresponding to the second set of accuracy values that are lower than the first set of accuracy values as accuracy-modifying data features included as part of an accuracy-modifying data feature-set, generate a first linear model based on the accuracy-modifying data features, generate a second linear model that is based on one of the accuracy-modifying data features having a weight that is highest relative to a remaining ones of the accuracy-modifying data features, and identify the second linear model as the generative model responsive to determining that the linear model accuracy value of the second linear model exceeds each of the first set of accuracy values.

In another embodiment, a method for generating an interpretive behavioral model is provided. The method is implemented by a computing device and includes iteratively fitting, after an iterative removal of each data feature from a data feature-set, a machine learning trained model to subsets of a plurality of data features to determine respective reduced feature-set outputs, determining one or more of the reduced feature-set outputs as corresponding to a second set of accuracy values that are lower than a first set of accuracy values associated with a complete data feature-set outputs, designating one or more of the iteratively removed data features that are associated with the one or more of the reduced feature-set outputs corresponding to the second set of accuracy values as accuracy-modifying data features, generating a first linear model based on the accuracy-modifying data features, generating a second linear model that is based on one of the accuracy-modifying data features having a weight that is highest relative to a remaining ones of the accuracy-modifying data features, and identifying the second linear model as the generative model responsive to determining that the linear model accuracy value of the second linear model exceeds each of the first set of accuracy values.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a non-limiting example of a computing device that is configured to perform one or more of the features and functionalities described in the present disclosure, according to one or more embodiments described and illustrated herein;

FIG. 2 depicts a flow chart for generating an interpretative behavioral model, according to one or more embodiments described and illustrated herein;

FIG. 3 depicts a flow chart in which an example generative model is fitted to an example input dataset, as a result of which an example output is generated, according to one or more embodiments described and illustrated herein;

FIG. 4A depicts an example operation of the method for generating an interpretative behavior model as described in the present disclosure, according to one or more embodiments described and illustrated herein;

FIG. 4B depicts the steps of identifying accuracy modifying data features, generating a linear model, and comparing the linear model with an ML trained model as part of the method of generating an interpretative behavioral model as described in the present disclosure, according to one or more embodiments described and illustrated herein;

FIG. 4C depicts the steps of the method for generating an interpretative behavioral model as described in the present disclosure, namely the steps of comparing the generated linear models to the machine learning trained model performing various actions based on the comparison; and

FIG. 5 depicts an automatic volume adjustment operation, according to one or more embodiments described and illustrated herein.

### DETAILED DESCRIPTION

Currently, different types of machine learning models may be fitted to a dataset, for the purpose of generating various outputs having a high level of accuracy. These machine learning models, when fitted to a robust and comprehensive input dataset, may enable the generation of outputs that are highly accurate. However, these outputs may not be interpretable. As such, while the outputs may be accurate and likely remain accurate across a large and varied dataset, the reasons for the generation of the output may remain unclear, rendering the machine learning models uninterpretable. While multiple behavioral models may better facilitate interpretation of input datasets and identification of one or more characteristics that influence an extent to which one or more particular outputs may result from the input datasets, these behavioral models are tested within and are accurate only within limited environments.

The embodiments described herein address and overcome the deficiencies of the above described conventional machine learning based models and behavioral models. In particular, the embodiments described herein provide for the generation of an interpretive behavior model that may be utilized to accurately generate a set of outputs based on a given set of inputs in addition to determining the extent to which each input, directly and indirectly, influenced or affected the generation of the set of outputs. For example, the interpretive behavioral model may determine the extent to which a consumer's decision to purchase a product was influenced by various factors, e.g., a discount sign near the product, a lighting near the product, the location of the product within a store, and so forth. The interpretative behavioral models may also determine the extent to which a combination of, e.g., the discount sign near a product and the lighting near the product, affected a consumer's decision to purchase the product.

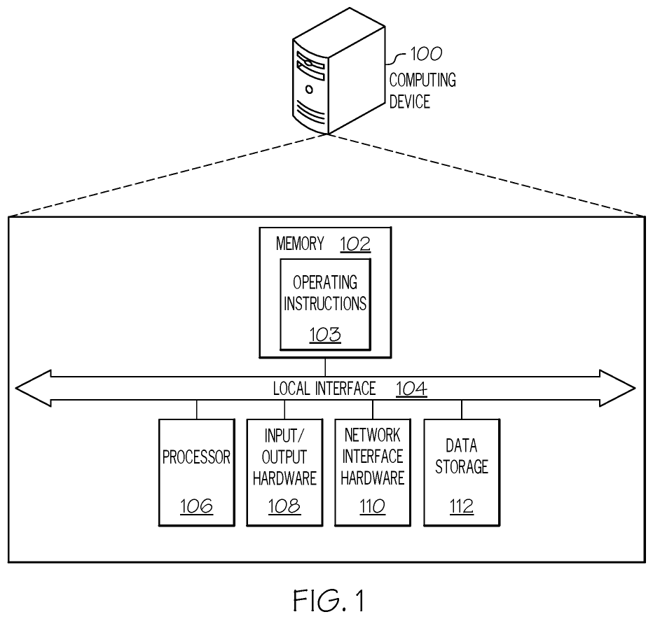

FIG. 1 depicts a non-limiting example of a computing device 100 that is configured to perform one or more of the features and functionalities described in the present disclosure, according to one or more embodiments described and illustrated herein. As illustrated, the computing device 100 includes a processor 106, input/output hardware 108, a network interface hardware 110, a data storage component 112, and memory 102. The memory 102 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable media may reside within the computing device 100 and/or a device that is external to the computing device 100.

The memory 102 may store operating instructions 103, each of which may be embodied as a computer program, firmware, and so forth. The memory 102 may comprise RAM, ROM, flash memories, hard drives, or any device capable of storing the operating instructions 103 such that the operating instructions 103 can be accessed by the processor 106. The operating instructions 103 may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the memory 102. Alternatively, the operating instructions 103 may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The processor 106 along with the memory 102 may operate as a controller for the computing device 100.

A local interface 104 is also included in FIG. 1 and may be implemented as a bus or other communication interface to facilitate communication among the components of the computing device 100. The processor 106 may include any processing component operable to receive and execute operating instructions 103 from the memory 102 (such as from a data storage component 136 and/or the memory 102). Accordingly, each of the one or more processors 202 may be a controller, an integrated circuit, a microchip, a computer, or any other computing device. As described above, the input/output hardware 108 may include and/or be configured to interface with speakers, microphones, and/or other input/output components.

The operating instructions 103 may include an operating system and/or other software for managing components of the computing device 100. It should be understood that while the component in FIG. 1 are illustrated as residing within the computing device 100, this is merely an example. In some embodiments, one or more of the components may reside external to the computing device 100 or within other devices. It should be understood that, while the computing device 100 is illustrated as a single device, this is also merely an example. As an example, one or more of the functionalities and/or components described herein may be provided by the computing device 100. Depending on the particular embodiments, any of these device may have similar components as those depicted in FIG. 1. To this end, any of these devices may include instructions for performing the functionality described herein.

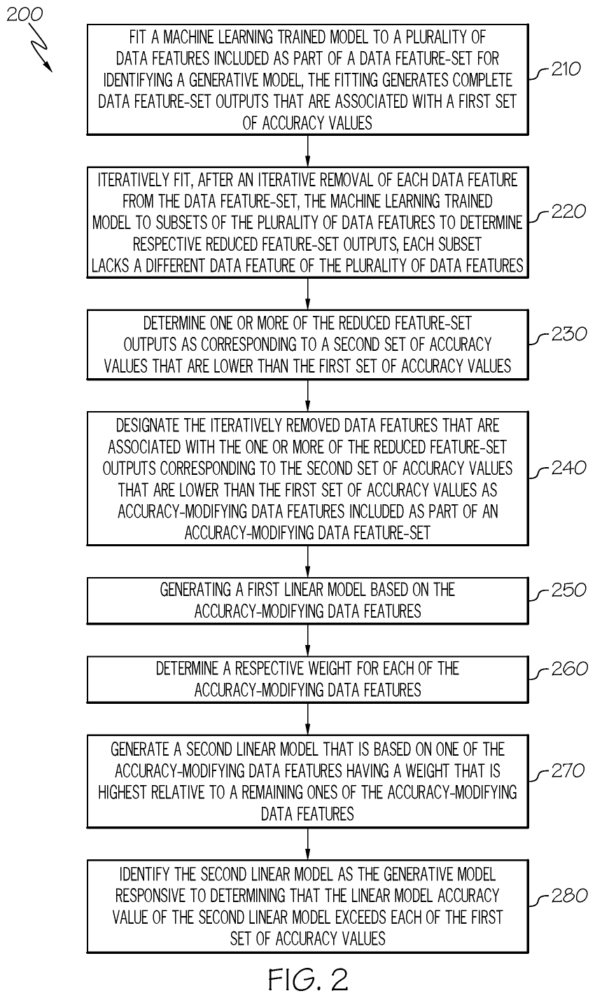

FIG. 2 depicts a flow chart 200 of an example process for generating an interpretative behavioral model, according to one or more embodiments described and illustrated herein. In embodiments, it is noted that the generation of the interpretative behavioral model may be implemented using a computing device 100 as illustrated in FIG. 1 and described above.

In embodiments, at block 210, the computing device 100 may fit a machine learning trained model to a plurality of data features included as part of a data feature-set for the purpose of identifying a generative model. The fitting of the machine learning trained model results in the generation of a set of complete data feature-set outputs that are associated with a first set of accuracy values.

At block 220, the computing device 100 may iteratively fit, after an iterative removal of each data feature from the data feature-set, the machine learning trained model to subsets of the plurality of data features to determine respective reduced feature-set outputs, and each subset lacks a different data feature of the plurality of data features.

At block 230, the computing device 100 may determine one or more of the reduced feature-set outputs as corresponding to a second set of accuracy values that are lower than the first set of accuracy values.

At block 240, the computing device 100 may designate the iteratively removed data features that are associated with the one or more of the reduced feature-set outputs corresponding to the second set of accuracy values that are lower than the first set of accuracy values as accuracy-modifying data features included as part of an accuracy-modifying data feature-set.

At block 250, the computing device 100 may generate a first linear model based on the accuracy-modifying data features.

At blocks 260 and 270, the computing device 100 may determine a respective weight for each of the accuracy-modifying data features and generate a second linear model that is based on one of the accuracy-modifying data features having a weight that is highest relative to a remaining ones of the accuracy-modifying data features. At block 280, the computing device 100 may identify the second linear model as the generative model responsive to determining that the linear model accuracy value of the second linear model exceeds each of the first set of accuracy values.

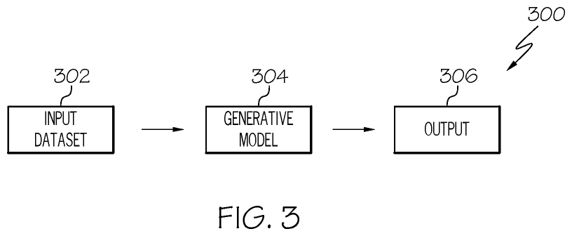

FIG. 3 depicts a flow chart 300 that describes an example generative model 304 that is fitted to example input dataset 302, as a result of which an example output dataset 306 is generated, according to one or more embodiments described and illustrated herein. In embodiments, the example data features may be based on various characteristics, traits, behavioral tendencies, and so forth, of a wide variety of people. For example, the example dataset may include shopping choices and preferences of individuals based on, e.g., whether these individuals are males, females, adults, children, executives, professionals, and so forth. The example data features may also include one or more factors that affect the choices and preferences made by these individuals. Additionally, in embodiments, the example dataset may include data of various aspects relating to a commercial establishment, e.g., a retail store, grocery store, or other comparable store. For example, the example dataset may include information relating to, e.g., the layout of the store, the manner in which different products are positioned on shelves, counters, and so forth around the store, the lighting around various locations in the store, electronic discount signs, cardboard discount signs, and so forth, around the store. The example dataset may also include information relating to which goods or services were purchased by one or more of these individuals, the dates, times associated with the purchase, and locations within the store in which these goods and services were purchased, and so forth.

In embodiments, the example generative model 304 may be fitted to the example input dataset 302 such that the model may analyze at least a subset of the information included in the example input dataset 302. Based on the analysis, the generative model 304 may generate the example output dataset 306, which may indicate that one or more individuals purchased a particular good or a particular service that is located within the store. In embodiments, the example generative model 304, which may be a neural network trained model, may generate the example output dataset 306 that is highly accurate and indicative of a strong correlation between the input and the output. For example, the generative model 304 may be a neural network trained model that accurately establishes the correlation between the example input dataset 302 and the example output dataset 306.

However, the generative model 304 may not provide information relating to the degree to which a particular data feature or specific details included in the example input dataset 302 influences the example output dataset 306. As such, while the generative model 304 may be helpful in predicting a strong correlation between the example input dataset 302 and the example output dataset 306, the model may not be useful in determining, e.g., whether a lighting near a product influenced the purchasing decision of an individual to a higher extent than a discount sign that may have been positioned within a few feet of the product, and so forth. In other words, the generative model 304 may fail to enable a deeper and more comprehensive understanding of user behavior, in particular, the extent to which a particular individual's decision to, e.g., purchase a product, was influenced by a particular factor, for example. For this reason, the example generative model 304 may not be considered interpretable.

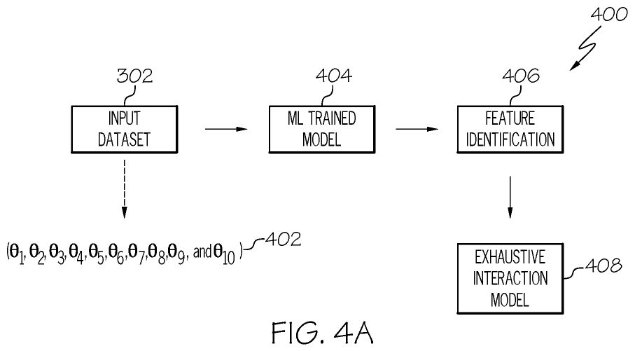

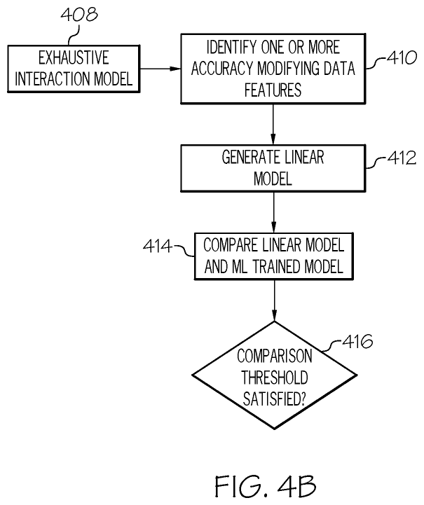

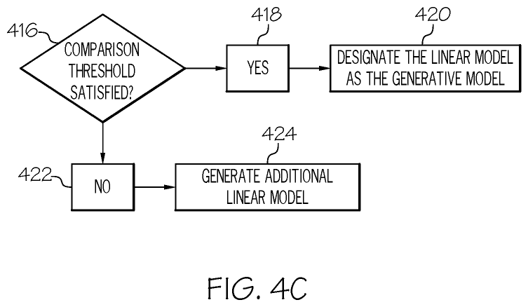

In embodiments, as stated above, an example behavioral model may be generated and fitting to a subset of the input dataset 302 and this model may provide insights into the extent and manner in which a particular feature (or set of features) in the subset of the input dataset 302 influences a purchase decision. For example, the example behavior model may enable a determination that a discount sign located near a product had an 80% influence on a user's decision to purchase the product and the lighting around the product (e.g., around a shelf on which a product was located) contributed to a 20% influence on the user's decision to purchase the product. However, such a behavioral model has certain limitations, namely that accuracy levels of the model may reduce with an increase in the size and diversity of the datasets. As such, both models, individually, fail to provide robust insights regarding the extent to which one or more factors influence user behavior. However, the processes described in FIG. 2 and FIGS. 4A-4C addresses and overcomes the deficiencies of these two models.

FIG. 4A depicts an example operation of the method for generating an interpretative behavior model as described in the present disclosure, according to one or more embodiments described and illustrated herein. As example dataset including example input dataset 302 may be fitting with a trained model 404. The example input dataset 302 may be represented in the form of theta values 402 (1-10), with each theta value representative of a particular input data feature. For example, a first theta value may be representative of a level of lighting within a store of commercial establishment, while another theta value may be representative of or describe a discount sign within the store that is located near various products. The theta values may also be representative of demographic information of various consumers, e.g., age, gender, professional qualifications, and so forth, and one or more purchase decisions made by these individuals. A variety of other features may also be represented by the theta values 402. The trained model 404 may be fitted to the input dataset 302 represented by the theta values 402 for the purpose of identifying at least a subset of the theta values 402 for further analysis.

As a non-limiting example, the trained model 404 may include one or more artificial neural networks (ANNs) and may include connections between nodes that form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error.

In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. The trained model 404 as described herein may utilize one or more ANN models as understood to those skilled in the art or as yet-to-be-developed to generate results as described in embodiments herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from audio, images, clustering algorithms, or combinations thereof.

As another non-limiting example, a convolutional neural network (CNN) may be utilized. For example, a convolutional neural network (CNN) may be used as an ANN that, in a field of machine learning, for example, is a class of deep, feed-forward ANNs that may be applied for audio-visual analysis. CNNs may be shift or space invariant and utilize shared-weight architecture and translation invariance characteristics. Additionally or alternatively, a recurrent neural network (RNN) may be used as an ANN that is a feedback neural network. RNNs may use an internal memory state to process variable length sequences of inputs to generate one or more outputs. In RNNs, connections between nodes may form a DAG along a temporal sequence. One or more different types of RNNs may be used such as a standard RNN, a Long Short Term Memory (LSTM) RNN architecture, and/or a Gated Recurrent Unit RNN architecture.

Returning to FIG. 4A, the identification of at least a subset of the theta values 402 for further analysis includes iteratively removing at least one theta value (corresponding to a data feature) from the theta values and fitting an example exhaustive interaction model 408 to the set of theta values that may be considered a reduced set of theta values 402. The manner in which the example exhaustive interaction model 408 is fitted to the reduced set of theta values 402 and the results or outputs of the fitting is described below.

FIG. 4B depicts the steps of identifying accuracy modifying data features, generating a linear model, and comparing the linear model with an ML trained model as part of the method of generating an interpretative behavioral model as described in the present disclosure, according to one or more embodiments described and illustrated herein. In embodiments, a step for identifying accuracy modifying data features includes a feature identification step (block 406) in which one or more of the theta values 402 are selected (e.g., manually or automatically) for fitting by an example exhaustive interaction model 408. In particular, an example exhaustive interaction model 408 may be fitted to a reduced set of theta values 402. For example, if a set of theta values include features or information relating to age and gender of individuals, purchasing decisions made by these individuals, and features or information relating to an environment in which purchasing decisions were made, e.g., lighting near a product, discount signs positioned near the product, location of a product near a check-out counter as opposed to a location of another product near a dairy section of a grocery store, etc., the reduced set of theta values 402 may corresponding to a set of features that lacks a particular feature. For example, the reduced set of theta values 402 may refer to a dataset that lacks a feature referring to the lighting near a product that was purchased by an individual.

Thereafter, the reduced feature set outputs may be compared with the complete data feature-set outputs as described in block 210 of FIG. 2 above. Specifically, in embodiments, the reduced feature-set outputs may be compared with the example output dataset 306 that is generated as a result of fitting the example generative model 304 to the example input dataset 302. In embodiments, the example output dataset 306 may correspond to or have a first set of accuracy values and these accuracy values may be compared with a second set of accuracy values of the reduced feature-set outputs, which are generated as a result of fitting the example exhaustive interaction model 408 to the reduced set of theta values 402.

After the second set of accuracy values are generated and compared with the first set of accuracy values, the feature referring to the lighting of a product, for example, may be placed back into the reduced dataset, thereby including all of the theta values 402 and completing the example input dataset 302. Thereafter, iteratively, another feature may be removed from the example input dataset 302 (i.e. from the theta values 402). For example, the discount sign positioned near a particular product that was purchased by the individual may be removed from the example input dataset 302 and the example exhaustive interaction model 408 may again be fitted to the newly generated reduced set of theta values 402, namely the reduced set that lacks the data features or information relating to the discount sign. Additionally, the latest iteration of the fitting of the example exhaustive interaction model 408 may result in the generation of an additional set of accuracy values (e.g., a third set of accuracy values), which will be compared with the first set of accuracy value of the completed data feature-set outputs as described in block 210.

In embodiments, if the second set of accuracy values are lower than that the first set of accuracy values, the computing device 100 may designate the theta value that was removed from the example input dataset 302—the lighting feature in one example—as an accuracy modifying data feature (block 410), as the removal of this feature resulted in a second set of accuracy values for the reduced feature-set outputs that were lower than the first set of accuracy values. In other words, as the removal of the lighting feature reduced the accuracy of the reduced feature-set outputs, in embodiments, the lighting feature may be determined to affect the purchasing decision of an individual relative to a product. For example, it may be determined that the removal of the lighting feature reduced the accuracy of the reduced feature-set outputs by 20 percent.

Similarly, if the third set of accuracy values are lower than the first set of accuracy values, the computing device 100 may designate the second theta value that was removed from the example input dataset 302—the discount sign feature in one example—as an accuracy modifying data feature (block 410), as the removal of this feature resulted in a third set of accuracy values for the reduced feature-set outputs that were lower than the first set of accuracy values. In other words, as the removal of the discount sign feature reduced the accuracy of the reduced feature-set output, in embodiments, the discount sign feature may be determined to affect the purchasing decision of an individual relative to a product. For example, it may be determined that the removal of the discount sign feature reduces the accuracy of the reduced feature-set outputs by 50 percent.

It is noted that, each one of the theta values 402 may be removed from the set of theta values 402 and the exhaustive interaction model 408 may be iteratively fitted after the removal of each theta value to the reduced set of theta values 402 in order to generate reduced feature-set outputs, which will then be iteratively compared with the first set of accuracy values. Thereafter, if the accuracy value of a particular set of reduced feature-set outputs is lower than the first set of accuracy values of the example input dataset 302, the particular theta value that was removed from the theta values 402 will be designated as an accuracy modifying data feature.

The computing device 100, upon identifying and designating at least a subset of the example input dataset 302 (i.e. one or more of the theta values 402) as accuracy modifying data features, may generate a first linear model (block 412) that is based on the determined accuracy modifying data features. In embodiments, the linear model may be a machine learning trained model that utilizes one or more of the artificial intelligence neural network based processes and algorithms described above. In embodiments, upon generating the first linear model (block 412), the computing device 100 may determine a weight value for each of the respective accuracy modifying data features and rank these respective weight values according their magnitude. For example, if the lighting feature described above caused a reduction in the accuracy of the reduced feature-set outputs by 50 percent, the weight value of the discount sign feature (e.g., designated as an accuracy modifying data feature) may be high (e.g., a weight value of 7 out of 10) as compared to the weight value of the lighting feature, which may be relatively lower (e.g., 3 out of 10). Thereafter, the first linear model (block 412) may be compared to the trained model 404 (block 416).

FIG. 4C depicts the steps of the method for generating an interpretative behavioral model as described in the present disclosure, namely the steps of comparing the generated linear models to the machine learning trained model performing various actions based on the comparison. In embodiments, upon the comparison of the first linear model (block 412) with the trained model 404 (block 414), if it is determined that an accuracy threshold is satisfied (block 416 and block 418), the first linear model may be designated as the generative model 304 illustrated in FIG. 3 (block 420). In contrast, if the accuracy threshold is not satisfied (block 422), an additional linear model (e.g., a second linear model) may be generated (block 424).

In embodiments, it is noted each of the first linear model (block 412) and any subsequent linear models that are generated may include main effect components and interaction components associated with the accuracy-modifying data features. In embodiments, each main effect component associated with a particular accuracy-modifying data feature is representative of a direct influence that at least one of the accuracy-modifying data features may have on the accuracy of the reduced feature-set outputs. Additionally, each interaction component is representative of an indirect influence that at least one of the accuracy-modifying data features has on the accuracy of the reduced feature-set outputs described above.

For example, a main effect of the lighting feature described above may be determined such the removal of the lighting feature may reduce the accuracy the reduced feature-set outputs by 20 percent and the main effect of the discount sign feature may be determined such that the removal of the discount sign feature reduces the accuracy of the reduced feature set outputs by 50 percent. As such, the direct influence (e.g., main effect) of each of the light feature and the discount sign feature on the reduced feature set outputs may be associated with, e.g., an importance of the feature in a purchase decision of an individual. For example, the lighting may affect an individual's product purchase decision to an extent that is lower than the extent to which the discount sign feature may affect the individual's product purchase decision. Consequently, the main effect of the discount sign feature may be higher than the main effect of the lighting feature. Additionally, the interaction component associated with the lighting feature may refer to an extent to which the accuracy of the reduced feature set outputs may be reduced if the discount feature in combination with lighting feature are removed from the example input dataset 302. In other words the interaction feature refer to the extent to which the combination of both the lighting feature and the discount sign feature affects the purchase decision of an individual.

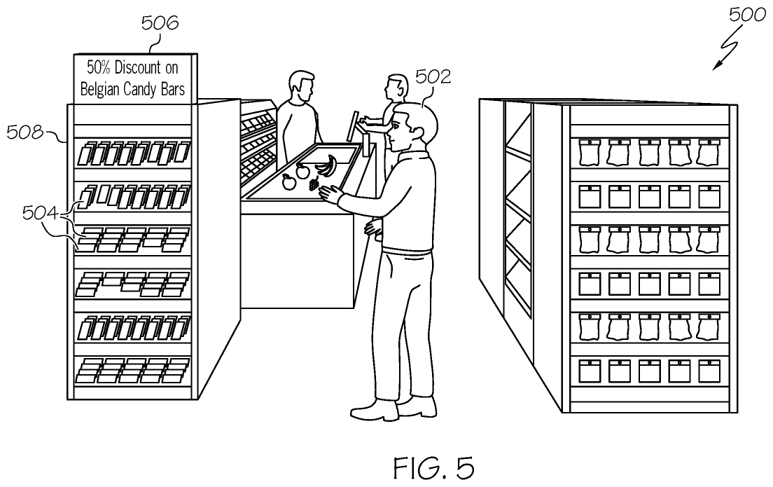

FIG. 5 depicts an example set of data features to which the generated interpretive behavioral model 500, based on the steps enumerated in FIGS. 2 and 4A-4C. In embodiments, the generated interpretive behavioral model 500 may be fitted to a plurality of data features and an set of one or more outputs may be determined. For example, data features may include details regarding a consumer 502 making a purchase decision within a grocery store. These details may include information about the location of various products, e.g., candy bars 504, that are located on a shelf that is with a few feet of a check-out counter of the grocery store. Additionally, an example discount sign 506 may be positioned on top of shelf 508 on which the candy bars 504 are positioned. Data features may also detail the location of the shelf relative to the check out counter. Additionally, data features may describe details regarding the consumer 502 such as, e.g., age, gender, and so forth.

In embodiments, the generated interpretive behavioral model may enable the determination and prediction of various behavior patterns of various consumers based on an analysis of data features describing the consumer 502. For example, the interpretive behavioral model may be utilized to determine that the example discount sign 506 influences the purchase decision of the consumer 502, namely the decision of the consumer 502 to purchase one of the candy bars 504 on the shelf 508 to a larger extent than the fact that the candy bars 504 are located on the shelf 508 that is situated near the checkout counter. The interpretive behavior model may also be utilize to analyze and discern the effects of other factors on the purchasing decisions of other individuals.

It should be understood that the embodiments of the present disclosure are directed to a method for generating an interpretive behavioral model is provided. The method is implemented by a computing device and includes fitting a machine learning trained model to a plurality of data features included as part of a data feature-set for identifying a generative model, the fitting generates complete data feature-set outputs that are associated with a first set of accuracy values, iteratively fitting, after an iterative removal of each data feature from the data feature-set, the machine learning trained model to subsets of the plurality of data features to determine respective reduced feature-set outputs, each subset lacks a different data feature of the plurality of data features, determining one or more of the reduced feature-set outputs as corresponding to a second set of accuracy values that are lower than the first set of accuracy values, designating the iteratively removed data features that are associated with the one or more of the reduced feature-set outputs corresponding to the second set of accuracy values that are lower than the first set of accuracy values as accuracy-modifying data features included as part of an accuracy-modifying data feature-set, generating a first linear model based on the accuracy-modifying data features, determining a respective weight for each of the accuracy-modifying data features, generating a second linear model that is based on one of the accuracy-modifying data features having a weight that is highest relative to a remaining ones of the accuracy-modifying data features, and identifying the second linear model as the generative model responsive to determining that the linear model accuracy value of the second linear model exceeds each of the first set of accuracy values.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method for generating an interpretive behavioral model that is implemented by a computing device, comprising:
fitting a machine learning trained model to a plurality of data features included as part of a data feature-set for identifying a generative model, the fitting generates complete data feature-set outputs that are associated with a first set of accuracy values;
iteratively fitting, after an iterative removal of each data feature from the data feature-set, the machine learning trained model to subsets of the plurality of data features to determine respective reduced feature-set outputs, each subset lacks a different data feature of the plurality of data features;
determining one or more of the reduced feature-set outputs as corresponding to a second set of accuracy values that are lower than the first set of accuracy values;
designating the iteratively removed data features that are associated with the one or more of the reduced feature-set outputs corresponding to the second set of accuracy values that are lower than the first set of accuracy values as accuracy-modifying data features included as part of an accuracy-modifying data feature-set;
generating a first linear model based on the accuracy-modifying data features;
generating a second linear model that is based on one of the accuracy-modifying data features having a weight that is highest relative to a remaining ones of the accuracy-modifying data features; and
identifying the second linear model as the generative model responsive to determining that the linear model accuracy value of the second linear model exceeds each of the first set of accuracy values.

2. The method of claim 1, further comprising comparing each of the reduced feature-set outputs with each of the complete data feature-set outputs.

3. The method of claim 1, wherein the first linear model including main effect components and interaction components for the accuracy-modifying data features.

4. The method of claim 3, wherein each main effect component is representative of a direct influence that at least one of the accuracy-modifying data features has on the reduced feature-set outputs that correspond to the second set of accuracy values that are lower than the first set of accuracy values.

5. The method of claim 3, wherein each interaction component is representative of an indirect influence that at one or more of the reduced feature-set outputs as corresponding to the second set of accuracy values that are lower than the first set of accuracy values.

6. The method of claim 1, further comprising ranking the accuracy-modifying data features from one of the accuracy-modifying data features having a highest weight to at least an additional one of the accuracy-modifying data features having a lower weight relative to the one of the accuracy-modifying data features having the highest weight.

7. The method of claim 1, further comprising comparing the linear model accuracy value of the second linear model with the first set of accuracy values associated with the machine learning trained model.

8. The method of claim 1, further comprising iteratively removing each data feature from the plurality of data features of the data feature-set.

9. The method of claim 1, determining a respective weight for each of the accuracy-modifying data features.

10. The method of claim 1, further comprising generating a third linear model responsive to determining that the linear model accuracy value of the second linear model does not exceed each of the first set of accuracy values.

11. The method of claim 10, wherein the generating of the third linear model is based the one of the accuracy-modifying data features having the weight that is the highest, and an additional one of the accuracy-modifying data features having an additional weight that is higher than an additional remaining ones of the accuracy-modifying data features, but lower than the one of the accuracy-modifying data features having the weight that is the highest.

12. The method of claim 11, further comprising identifying the third linear model as the generative model responsive to determining that a third linear model accuracy value of the third linear model exceeds each of the first set of accuracy values.

13. A system comprises:
one or more processors included as part of a computing device;
non-transitory computer readable medium storing instructions that, when executed by the one or more processors, cause the computing device to:
fit a machine learning trained model to a plurality of data features included as part of a data feature-set for identifying a generative model, the fitting generates complete data feature-set outputs that are associated with a first set of accuracy values;
iteratively fit, after an iterative removal of each data feature from the data feature-set, the machine learning trained model to subsets of the plurality of data features to determine respective reduced feature-set outputs, each subset lacks a different data feature of the plurality of data features;
determine one or more of the reduced feature-set outputs as corresponding to a second set of accuracy values that are lower than the first set of accuracy values;
designate the iteratively removed data features that are associated with the one or more of the reduced feature-set outputs corresponding to the second set of accuracy values that are lower than the first set of accuracy values as accuracy-modifying data features included as part of an accuracy-modifying data feature-set;
generate a first linear model based on the accuracy-modifying data features;
determine a respective weight for each of the accuracy-modifying data features;
generate a second linear model that is based on one of the accuracy-modifying data features having a weight that is highest relative to a remaining ones of the accuracy-modifying data features; and
identify the second linear model as the generative model responsive to determining that the linear model accuracy value of the second linear model exceeds each of the first set of accuracy values.

14. The system of claim 13, wherein the non-transitory computer readable medium storing instructions that, when executed by the one or more processors, further cause the computing device to compare each of the reduced feature-set outputs with each of the complete data feature-set outputs.

15. The system of claim 13, wherein the first linear model including main effect components and interaction components for the accuracy-modifying data features.

16. The system of claim 13, wherein the non-transitory computer readable medium storing instructions that, when executed by the one or more processors, further cause the computing device to rank the accuracy-modifying data features from one of the accuracy-modifying data features having a highest weight to at least an additional one of the accuracy-modifying data features having a lowest weight relative to the one of the accuracy-modifying data features having the highest weight.

17. The system of claim 13, wherein the non-transitory computer readable medium storing instructions that, when executed by the one or more processors, further cause the computing device to compare the linear model accuracy value of the second linear model with the first set of accuracy values associated with the machine learning trained model.

18. The system of claim 13, wherein the non-transitory computer readable medium storing instructions that, when executed by the one or more processors, further cause the computing device to iteratively remove each data feature from the plurality of data features of the data feature-set.

19. The system of claim 13, wherein the non-transitory computer readable medium storing instructions that, when executed by the one or more processors, further cause the computing device to generate a third linear model responsive to determining that the linear model accuracy value of the second linear model does not exceed each of the first set of accuracy values.

20. A method for generating an interpretive behavioral model that is implemented by a computing device, comprising:
iteratively fitting, after an iterative removal of each data feature from a data feature-set, a machine learning trained model to subsets of a plurality of data features to determine respective reduced feature-set outputs;
determining one or more of the reduced feature-set outputs as corresponding to a second set of accuracy values that are lower than a first set of accuracy values associated with a complete data feature-set outputs;
designating one or more of the iteratively removed data features that are associated with the one or more of the reduced feature-set outputs corresponding to the second set of accuracy values as accuracy-modifying data features;
generating a first linear model based on the accuracy-modifying data features;
generating a second linear model that is based on one of the accuracy-modifying data features having a weight that is highest relative to a remaining ones of the accuracy-modifying data features; and
identifying the second linear model as the generative model responsive to determining that the linear model accuracy value of the second linear model exceeds each of the first set of accuracy values.
